(19) United States
(12) Patent Application Publication
(10) Pub. No.: US 2013/0050816 A1
(43) Pub. Date: Feb. 28, 2013

(54) THREE-DIMENSIONAL IMAGE PROCESSING APPARATUS AND THREE-DIMENSIONAL IMAGE PROCESSING METHOD

(71) Applicant: Kazuki Kuwahara, Saitama-shi (JP)

(72) Inventor: Kazuki Kuwahara, Saitama-shi (JP)

(73) Assignee: KABUSHIKI KAISHA TOSHIBA, Tokyo (JP)

(21) Appl. No.: 13/451,474

(22) Filed: Apr. 19, 2012

(30) Foreign Application Priority Data
Aug. 31, 2011 (JP) 2011-189349

(51) Int. Cl. G02B 27/22

(52) U.S. Cl. 359/462

(57) ABSTRACT

In one embodiment, a three-dimensional image processing apparatus includes: an imaging module configure to image a field including a front of a display; a face detection module configure to detect a face of a user from an image imaged by the imaging module; and a controller configured to , when the face of the user is undetectable by the face detection module, notify that the face is undetectable, and control the display to display a first image indicating a field where the three-dimensional image is recognizable as a three-dimensional body.

### CROSS-REFERENCE TO RELATED APPLICATION

This application is based upon and claims the benefit of priority from Japanese Patent Application No. 2011-189349, filed on Aug. 31, 2011; the entire contents of which are incorporated herein by reference.

### FIELD

Embodiments relate generally to a three-dimensional image processing apparatus and a three-dimensional image processing method.

### BACKGROUND

In recent years, image processors through which a three-dimensional image can be viewed (hereinafter, described as three-dimensional image processors) have been developed and released. Some three-dimensional image processors employ an integral imaging system (also called an integral photography system) in which pixels of a plurality of images having parallax (multi-parallax image) are discretely arranged in one image (hereinafter, described as a synthesized image) and orbits of light beams from pixels constituting the synthesized image are controlled using a lenticular lens or the like to cause an observer to perceive a three-dimensional image.

The integral imaging system has an advantage of requiring no dedicated glasses for viewing the three-dimensional image but has a problem that the field where the image can be recognized as a three-dimensional body (hereinafter, described as a visual field) is limited. When the user is located outside the visual field, the user cannot recognize the image as a three-dimensional body due to occurrence of so-called reverse view, crosstalk, or the like. For this reason, a three-dimensional image processor is proposed in which a camera is installed so that the user is detected from an image imaged by the camera, whether the position of the detected user is located inside the visual field is judged, and the three-dimensional image is controlled based on the judgment result.

### BRIEF DESCRIPTION OF THE DRAWINGS

FIG. 1 is a configuration diagram of a three-dimensional image processor according to an embodiment.

FIG. 2 is a view illustrating an example of an image displayed on a display screen.

FIG. 3 is a view illustrating an example of an image displayed on the display screen.

FIG. 4 is a flowchart illustrating the operation of the three-dimensional image processor according to the embodiment.

### DETAILED DESCRIPTION

Hereinafter, an embodiment will be described referring to the drawings.

### Embodiment

A three-dimensional image processor (a three-dimensional image processing apparatus) according to an embodiment includes an imaging module configured to image a field including a front of a display, the display configured to display a three dimensional image, a face detection module configured to detect a face of a user from an image imaged by the imaging module, and a controller configured to, when the face of the user is undetectable by the face detection module, notify that the face is undetectable, and control the display to display a first image indicating a field where the three-dimensional image is recognizable as a three-dimensional body.

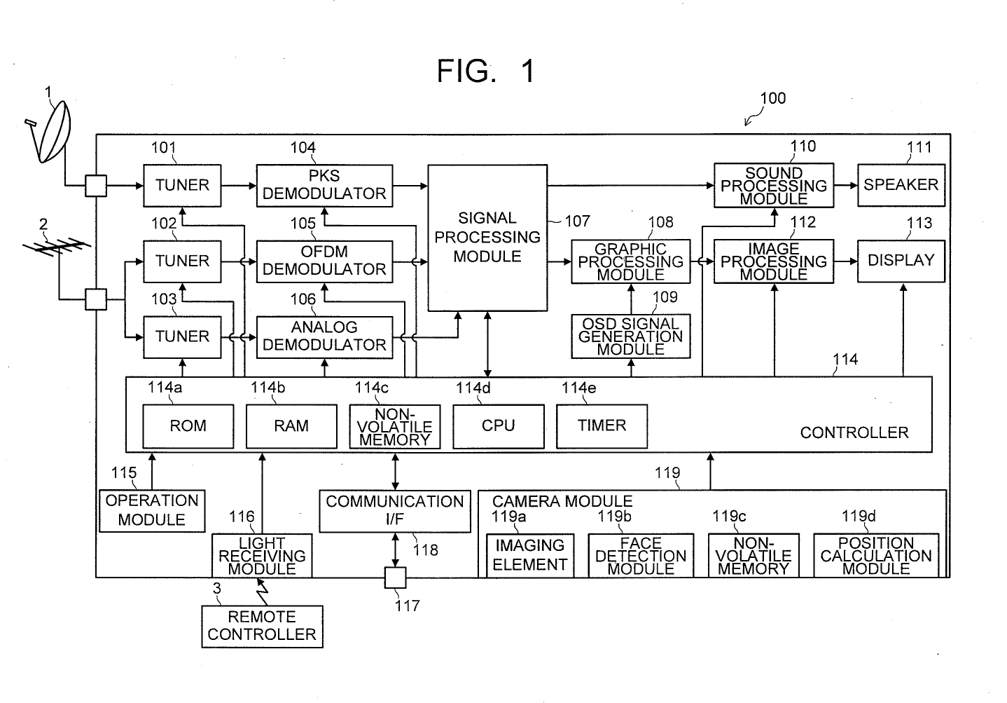

FIG. 1 is a configuration diagram of a three-dimensional image processing apparatus 100 (hereinafter, described as a three-dimensional image processor 100) according to an embodiment. The three-dimensional image processor 100 is, for example, a digital television. The three-dimensional image processor 100 presents a three-dimensional image to a user by the integral imaging system of discretely arranging pixels of a plurality of images having parallax (multi-view images) in one image (hereinafter, described as a synthesized image), and controlling the orbits of light beams from the pixels constituting the synthesized image using a lenticular lens to cause an observer to perceive a three-dimensional image.

### (Configuration of the Three-Dimensional Image Processor 100)

The three-dimensional image processor 100 according to the embodiment includes a tuner 101, a tuner 102, a tuner 103, a PSK (Phase Shift Keying) demodulator 104, an OFDM (Orthogonal Frequency Division Multiplexing) demodulator 105, an analog demodulator 106, a signal processing module 107, a graphic processing module 108, an OSD (On Screen Display) signal generation module 109, a sound processing module 110, a speaker 111, an image processing module 112, the display 113, the controller 114, an operation module 115 (operation accepting module), a light receiving module 116 (operation accepting module), a terminal 117, a communication I/F (Inter Face) 118, and the camera module 119.

The tuner 101 selects a broadcast signal of a desired channel from satellite digital television broadcasting received by an antenna 1 for receiving BS/CS digital broadcasting, based on the control signal from the controller 114. The tuner 101 outputs the selected broadcast signal to the PSK demodulator 104. The PSK demodulator 104 demodulates the broadcast signal inputted from the tuner 101 and outputs the demodulated broadcast signal to the signal processing module 107, based on the control signal from the controller 114.

The tuner 102 selects a digital broadcast signal of a desired channel from terrestrial digital television broadcast signal received by an antenna 2 for receiving terrestrial broadcasting, based on the control signal from the controller 114. The tuner 102 outputs the selected digital broadcast signal to the OFDM demodulator 105. The OFDM demodulator 105 demodulates the digital broadcast signal inputted from the tuner 102 and outputs the demodulated digital broadcast signal to the signal processing module 107, based on the control signal from the controller 114.

The tuner 103 selects an analog broadcast signal of a desired channel from terrestrial analog television broadcast signal received by the antenna 2 for receiving terrestrial broadcasting, based on the control signal from the controller 114. The tuner 103 outputs the selected analog broadcast signal to the analog demodulator 106. The analog demodulator 106 demodulates the analog broadcast signal inputted from the tuner 103 and outputs the demodulated analog broadcast signal to the signal processing module 107, based on the control signal from the controller 114.

The signal processing module 107 generates an image signal and a sound signal from the demodulated broadcast signals inputted from the PSK demodulator 104, the OFDM demodulator 105, and the analog demodulator 106. The signal processing module 107 outputs the image signal to the graphic processing module 108. The signal processing module 107 further outputs the sound signal to the sound processing module 110.

The OSD signal generation module 109 generates an OSD signal and outputs the OSD signal to the graphic processing module 108 based on the control signal from the controller 114.

The graphic processing module 108 generates a plurality of pieces of image data (multi-view image data) corresponding to two parallaxes or nine parallaxes from the image signal outputted from the signal processing module 107 based on the instruction from the controller 114. The graphic processing module 108 discretely arranges pixels of the generated multi-view images in one image to thereby convert them into a synthesized image having two parallaxes or nine parallaxes. The graphic processing module 108 further outputs the OSD signal generated by the OSD signal generation module 109 to the image processing module 112.

The image processing module 112 converts the synthesized image converted by the graphic processing module 108 into a format which can be displayed on the display 113 and then outputs the converted synthesized image to the display 113 to cause it to display a three-dimensional image. The image processing module 112 converts the inputted OSD signal into a format which can be displayed on the display 113 and then outputs the converted OSD signal to the display 113 to cause it to display an image corresponding to the OSD signal.

The display 113 is a display for displaying a three-dimensional image of the integral imaging system including a lenticular lens for controlling the orbits of the light beams from the pixels.

The sound processing module 110 converts the inputted sound signal into a format which can be reproduced by the speaker 111 and then outputs the converted sound signal to the speaker 111 to cause it to reproduce sound.

On the operation module 115, a plurality of operation keys (for example, a cursor key, a decision (OK) key, a BACK (return) key, color keys (red, green, yellow, blue) and so on) for operating the three-dimensional image processor 100 are arranged. The user depresses the above-described operation key, whereby the operation signal corresponding to the depressed operation key is outputted to the controller 114.

The light receiving module 116 receives an infrared signal transmitted from the remote controller 3. On the remote controller 3, a plurality of operation keys (for example, a cursor key, a decision key, a BACK (return) key, color keys (red, green, yellow, blue) and so on) for operating the three-dimensional image processor 100 are arranged. The user depresses the above-described operation key, whereby the infrared signal corresponding to the depressed operation key is emitted. The light receiving module 116 receives the infrared signal emitted from the remote controller 3. The light receiving module 116 outputs an operation signal corresponding to the received infrared signal to the controller 114.

The user can operate the operation module 115 or the remote controller 3 to cause the three-dimensional image processor 100 to perform various operations and change the settings of the three-dimensional image processor 100. For example, the user can change the settings of the parallax, auto-tracking, alert screen display and so on of the three-dimensional image processor 100. For the setting of the parallax, the user can set whether to view the three-dimensional image with two parallaxes or nine parallaxes. The setting of the parallax selected by the user is stored in the non-volatile memory 114c of the controller 114. Note that the above-described number of parallaxes (two parallaxes or nine parallaxes) is an example, and another number of parallaxes (for example, four parallaxes or six parallaxes) may be employed.

For the setting of the auto-tracking, the user can set whether to turn ON or OFF the auto-tracking. When the auto-tracking is ON, the visual field is automatically formed at the position of the user calculated based on the image imaged by the camera module 119. When the auto-tracking is ON, the position of the user is calculated every predetermined time (for example, several tens of seconds to several minutes), and the visual field is formed at the calculated position of the user. On the other hand, when the auto-tracking is OFF, the visual field is formed at the position of the user when the user directs that.

Note that the formation of the visual field is performed as follows. For example, when the visual field is desired to be moved in the front-rear direction of the display 113, the visual field is moved in the front-rear direction of the display 113 by increasing or decreasing the distance between display screen and the aperture of the opening module of the lenticular lens. When the distance is increased, the visual field is moved to the rear of the display 113. On the other hand, when the distance is decreased, the visual field is moved to the front of the display 113.

When the visual field is desired to be moved in the right-left direction of the display 113, the visual field is moved in the right-left direction of the display 113 by shifting the display image to right and left. The visual field is moved to the left side of the display 113 by shifting the display image to the left. On the other hand, the visual field is moved to the right side of the display 113 by shifting the display image to the right.

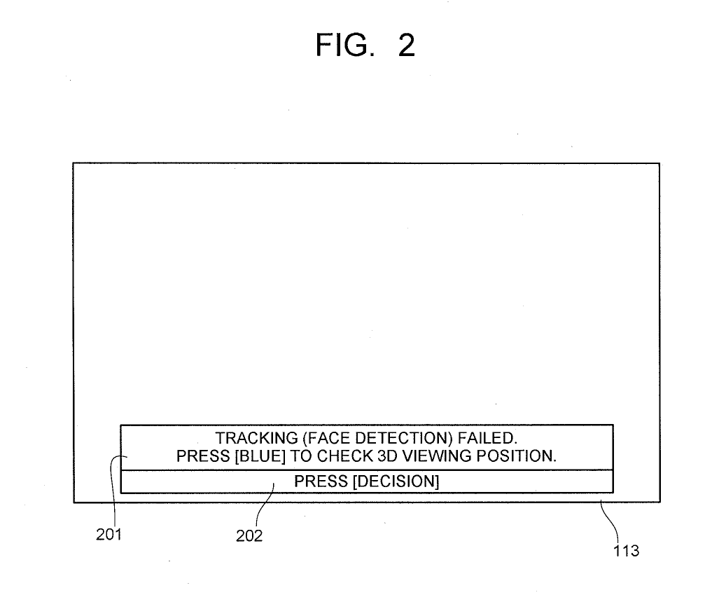

For the setting of the alert screen display, it is possible to set whether or not to display a later-described alert screen (see FIG. 2). When the alert screen display is ON, the later-described alert screen (see FIG. 2) is displayed on the display 113. On the other hand, when the alert screen display is OFF, the later-described alert screen (see FIG. 2) is not displayed on the display 113.

The terminal 117 is a USB terminal, a LAN terminal, an HDMI terminal, or an iLINK terminal for connecting an external terminal (for example, a USB memory, a DVD storage and reproduction device, an Internet server, a PC or the like).

The communication I/F 118 is a communication interface with the above-described external terminal connected to the terminal 117. The communication I/F 118 converts the control signal and the format of data and so on between the controller 114 and the above-described external terminal.

The camera module 119 is provided on the lower front side or the upper front side of the three-dimensional image processor 100. The camera module 119 includes an imaging element 119a, a face detection module 119b, a non-volatile memory 119c, and a position calculation module 119d. The imaging element 119a is, for example, a CMOS image sensor or a CCD image sensor. The imaging element 119a images a field including the front of the three-dimensional image processor 100.

The face detection module 119b detects the face of a user from the image imaged by the imaging element 119a . The face detection module 119b provides a unique number (ID) for the detected face of the user. For the face detection, a known method can be used. For example, the methods of the face recognition are roughly classified into a method of directly geometrically comparing visual features and a method of statistically digitizing the image and comparing the numeric value to a template. Either method may be used to detect the face in this embodiment.

When the face detection module 119b could not detect the face, the non-volatile memory 119c stores the image at the time when the face could not be detected. The possible cases that the face cannot be detected include, for example, a case that the user looks down for operation of the remote controller 3 and a case that the user speaks aside to another user sitting beside. The image stored in the non-volatile memory 119c is displayed on the display 113, so that the user can easily understand and guess why the face detection was failed.

Note that for the failure of face detection, it is necessary to detect the face of the user from the image imaged by the imaging element 119a, for example, performed once every several seconds and judge that the detection of the face has been failed if the detection of the face was failed a plurality of times (for example, three times) in succession.

The position calculation module 119d calculates the position coordinates of the user whose face has been detected by the face detection module 119b. For the calculation of the position coordinates of the user, a known method can be used. For example, the position coordinates of the user whose face has been detected may be calculated based on the distance from the right eye to the left eye of the face detected by the face detection module 119b and the coordinates from the center of the imaged image to the face center (the middle between the right eye and the left eye).

From the coordinates from the center of the imaged image to the face center, the position of the user in the top-down direction and in the right-left direction (an x-y plane) can be calculated. Further, from the distance from the right eye to the left eye of the face, the distance from the imaging element 119a to the user can be calculated. Normally, the distance between the right eye and the left eye of a human being is about 65 mm, so that if the distance between the right eye and the left eye is found, the distance from the imaging element 119a to the user can be calculated.

Further, the position calculation module 119d provides the same ID as the ID provided by the face detection module 119b, to data on the calculated position coordinates. Note that the position coordinates are only needs to be recognized as three-dimensional coordinate data, and may be expressed by any one of generally-known coordinate systems (for example, orthogonal coordinate system, polar coordinate system, spherical-coordinate system).

When the face of the user cannot be detected in the image imaged by the imaging element 119a, the camera module 119 outputs an alert signal and the image at the time when the face could not be detected which is stored in the non-volatile memory 119c to the controller 114. On the other hand, when the face of the user was able to be detected, the camera module 119 outputs the position coordinates calculated by the position calculation module 119d together with the ID which has been provided by the face detection module 119b. Note that the face detection of the user and the calculation of the position coordinates of the detected face (user) may be performed by the later-described controller 114.

The controller 114 includes a ROM (Read Only Memory) 114a, a RAM (Random Access Memory) 114b, a non-volatile memory 114c, and a CPU 114d. In the ROM 114a, a control program executed by the CPU 114d is stored. The RAM 114b serves as a work area for the CPU 114d. In the non-volatile memory 114c, various kinds of setting information (for example, the setting information on the above-described parallax, tracking, alert screen display), visual field information and so on are stored. The visual field information is the distribution of the visual field in the actual space made into three-dimensional coordinate data. The visual field information for the two parallaxes and the nine parallaxes is stored in the non-volatile memory 114c.

The controller 114 controls the three-dimensional image processor 100. Concretely, the controller 114 controls the operation of the three-dimensional image processor 100 based on the operation signals inputted from the operation module 115 and the light receiving module 116 and the setting information stored in the non-volatile memory 114c. Hereinafter, a representative control operation of the controller 114 will be described.

### (Control of the Number of Parallaxes)

When the parallax stored in the non-volatile memory 114c is two parallaxes, the controller 114 instructs the graphic processing module 108 to generate image data for the two parallaxes from the image signal outputted from the signal processing module 107. When the parallax stored in the non-volatile memory 114c is nine parallaxes, the controller 114 instructs the graphic processing module 108 to generate image data for the nine parallaxes from the image signal outputted from the signal processing module 107.

### (Control of Tracking)

When the auto-tracking stored in the non-volatile memory 114c is ON, the controller 114 calculates the position of the user from the image imaged by the camera module 119 every predetermined time (for example, several tens of seconds to several minutes). The controller 114 controls the orbits of the light beams from the pixels of the display 113 so that the visual field is formed at the calculated position. When the auto-tracking stored in the non-volatile memory 114c is OFF, the controller 114 calculates the position of the user from the image imaged by the camera module 119 when the user operates the operation module 115 or the remote controller 3 to direct formation of the visual field. The controller 114 controls the orbits of the light beams from the pixels of the display 113 so that the visual field is formed at the calculated position.

### (Display of Alert Screen)

When the alert signal is transmitted from the camera module 119, the controller 114 instructs the OSD signal generation module 109 to generate an image signal notifying that the face cannot be detected, and the display 113 to display it. FIG. 2 is an image view actually displayed on the display 113. As illustrated in FIG. 2, a message that the face could not be detected, “Tracking (face detection) failed.” and a message to promote the subsequent operation that “Press [blue] to check 3D viewing position.” are displayed in a display frame 201 located on the lower side of the display 113.

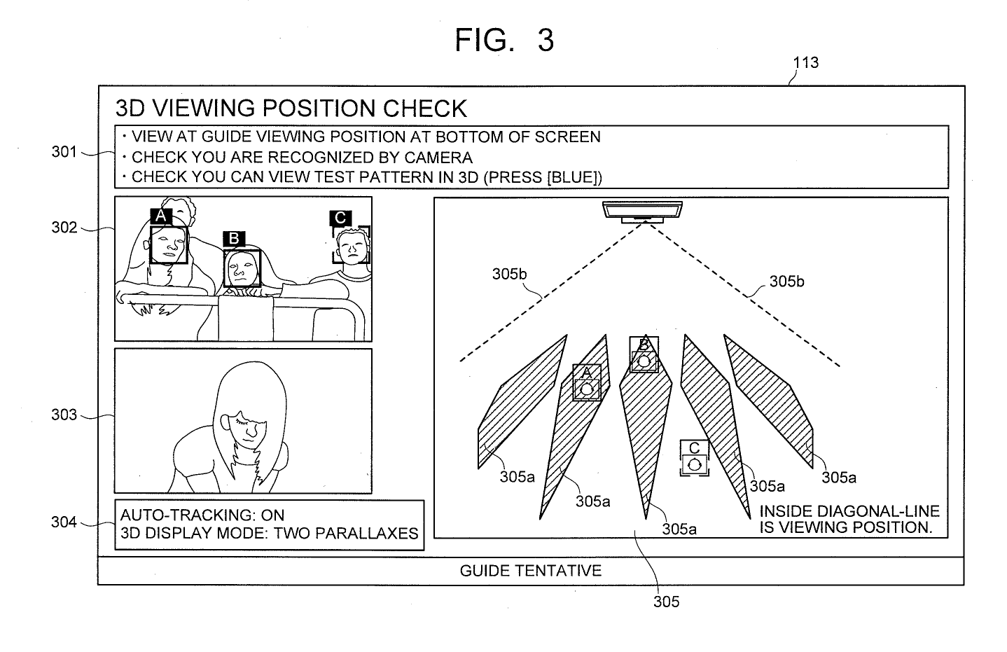

Further, in a display frame 202, “Press [decision]” is displayed. When the user depresses the blue color key on the operation module 115 or the remote controller 3, a later-described viewing position check screen in FIG. 3 is displayed on the display 113. When the user depresses the decision key on the operation module 115 or the remote controller 3, the frames 201, 202 and the messages in the frames 201, 202 in FIG. 2 are hidden. When the user has set the alert screen display OFF, the image illustrated in FIG. 2 is not displayed.

### (Display of the Viewing Position Check Screen)

When the alert screen illustrated in FIG. 2 is displayed on the display 113 and then the user depresses the blue color key on the operation module 115 or the remote controller 3, the controller 114 instructs the OSD signal generation module 109 to generate an image signal for checking the viewing position of the three-dimensional image and the display 113 to display it. Though the blue color key is assigned to the operation of moving to the viewing position check screen in this embodiment, another operation key may be assigned.

FIG. 3 is an image view actually displayed on the display 113. As illustrated in FIG. 3, display frames 301 to 305 are displayed on the display 113. In the display fames 301 to 305, various kinds of information required for the user to view the three-dimensional image inside the visual field are presented.

In the display frame 301, the items required for the user to view the image inside a field where the user can recognize the image as a three-dimensional body, that is, the visual field are displayed.

In the display frame 302, an image imaged by the imaging element 119a of the camera module 119 is displayed. The user can check the orientation and the position of the face and whether the face is actually recognized, from the image displayed in the display frame 302. When the face of the user is recognized, the recognized face of the user is surrounded by a frame. Above the frame, the ID (an alphabet in this embodiment) which has been provided by the face detection module 119b of the camera module 119 is displayed.

In this embodiment, the display form of the frame is different depending on whether the user is located inside or outside the visual field. In the example illustrated in FIG. 3, when the user is located inside the visual field, the frame surrounding the face of the user is drawn by a solid line. When the user is located outside the visual field, the frame surrounding the face of the user is drawn by a broken line. It is found that users A, B are inside visual fields and a user C is outside a visual field in the example illustrated in FIG. 3.

When the user is located outside the visual field, the user cannot recognize the image as a three-dimensional body due to occurrence of so-called reverse view, crosstalk, or the like. In this example, the display form of the frame is different depending on whether the user is inside the visual field, so that it can be easily checked whether the position of the user is inside or outside the visual field. Note that though the kind of the line (solid line, broken line) of the frame surrounding the face of the user is made different depending on whether the position of the user is inside the visual field in the example illustrated in FIG. 3, other display forms, for example, the shape (rectangle, triangle, circle or the like), the color, or the like of the frame may be made different depending on whether the position of the user is inside the visual field. Even in this manner, it can be easily recognized whether the position of the user is inside or outside the visual field.

The controller 114 judges whether the position of the user is inside the visual field based on the position coordinates of the user calculated by the position calculation module 119d and the visual field information stored in the non-volatile memory 114c. In this event, the controller 114 changes the visual field information referred to depending on whether the setting of the number of parallaxes is two or nine. In other words, the controller 114 refers to the visual field information for two parallaxes when the setting of the number of parallaxes is the two parallaxes. The controller 114 refers to the visual field information for nine parallaxes when the setting of the number of parallaxes is nine parallaxes.

In the display frame 303, the image at the time when the face could not be detected which is stored in the non-volatile memory 119c is displayed. By checking the image displayed in the display frame 303, the user can easily understand why the face detection was failed. For example, in the example illustrated in FIG. 3, it can be understood that the face could not be detected because the user looked down.

In the display frame 304, the current setting information is displayed. Concretely, whether the number of parallaxes of the three-dimensional image is two or nine and whether the auto-tracking is ON or OFF are displayed.

In the display frame 305, a visual field 305a (diagonal-line part) that is a field where the three-dimensional image can be viewed in three dimensions, and the position information (icons indicating users, frames surrounding the icons) of the users calculated by the position calculation module 119d of the camera module 119, and IDs (alphabets) are displayed as a bird's eye view. The bird's eye view displayed in the display frame 305 is displayed based on the visual field information stored in the non-volatile memory 114c and the position coordinates calculated by the position calculation module 119d.

By referring to the bird's eye view displayed in the display frame 305, the user can easily understand whether or not his or her face is recognized, that, when recognized, the face is located inside the visual field 305a, and that, when the face is located outside the visual field 305a, movement in which direction brings the face into the visual field 305a.

In this embodiment, the display form for the position information of the user indicated in the bird's eye view is different also depending on whether the user is inside or outside the visual field. In the example illustrated in FIG. 3, when the user is inside the visual field, the frame surrounding the icon indicating the user is drawn by a solid line. When the user is outside the visual field, the frame surrounding the icon indicating the user is drawn by a broken line. In the example illustrated in FIG. 3, it is found that the users A, B are inside the visual fields and the user C is outside the visual field. Note that though the kind of the line (solid line, broken line) of the frame surrounding the icon indicating the user is made different depending on whether the position of the user is inside the visual field in the example illustrated in FIG. 3, other display forms, for example, the shape (rectangle, triangle, circle, or the like), the color, or the like of the frame surrounding the icon may be made different depending on whether the position of the user is inside the visual field.

In the image displayed in the display frame 302 and the bird's eye view displayed in the display frame 305, the same alphabet is displayed in the upper module for the same user. Therefore, even when a plurality of users, that is, viewers exist, the individual user can easily understand the position where the user is located. Note that though the same alphabet is displayed for the same user in FIG. 3, the same user may be indicated by another method, for example, the color or the shape of the frame.

Broken lines 305b in the display frame 305 indicate the boundaries of the imaging range by the imaging element 119a. More specifically, the rage actually imaged by the imaging element 119a and displayed inside the display frame 302 is a range on the lower side of the broken lines 305b. Therefore, display of an upper left range and an upper right range of the broken lines 305b inside the display frame 305 may be omitted in the display frame 305.

### (Display of Test Pattern)

When the viewing position check screen illustrated in FIG. 3 is displayed on the display 113 and then the user depresses the blue color key on the operation module 115 or the remote controller 3, the controller 114 instructs the OSD signal generation module 109 to generate an image signal for displaying a test pattern of the three-dimensional image and the display 113 to display it. Though the blue color key is assigned to the operation of shifting to the test pattern in this embodiment, another operation key may be assigned.

The OSD signal generation module 109 generates an image signal of the test pattern and outputs it to the display 113. On the display 113, the test pattern of the three-dimensional image is displayed on the display 113. The user can check whether to be able to view the image displayed on the display 113 as a three-dimensional body at the current position, that is, to be located inside the visual field, through the test pattern.

### (Update of Visual Field Information)

The controller 114 recalculates the distribution of a new visual field every time the visual field is changed by the auto-tracking or the operation by the user, and updates the visual field information stored in the non-volatile memory 114c.

### (Operation of the Three-Dimensional Image Processor 100)

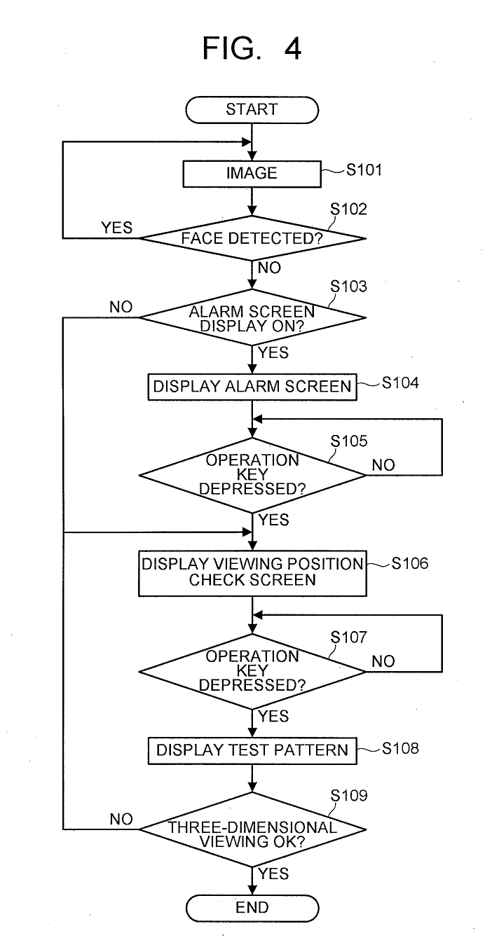

FIG. 4 is a flowchart illustrating the operation of the three-dimensional image processor 100. Hereinafter, the operation of the three-dimensional image processor 100 will be described referring to FIG. 4.

The camera module 119 images the front of the three-dimensional image processor 100 by the imaging element 119a (Step S101). The face detection module 119b detects the face from the image imaged by the imaging element 119a (Step S102). When the face can be detected (Yes at Step S102), the camera module 119 returns to the operation at Step S101.

When the face detection module 119b cannot detect the face (No at Step S102), the camera module 119 transmits an alert signal to the controller 114. Upon receipt of the alert signal, the controller 114 refers to the setting of the alert screen display stored in the non-volatile memory 114c and checks whether the setting of the alert screen display is ON (Step S103).

When the setting of the alert display screen display is ON (Yes at Step S103), the controller 114 instructs the OSD signal generation module 109 to generate an image signal notifying that the face cannot be detected and the display 113 to display it. The OSD signal generation module 109 generates an image signal and outputs it to the display 113 based on the instruction from the controller 114. On the display 113, the alert screen illustrated in FIG. 2 is displayed (Step S104). When the setting of the alert screen display is OFF (No at Step S103), the controller 114 performs a later-described operation at Step S106.

After the alert screen is displayed, the controller 114 judges whether the blue color key on the operation module 115 or the remote controller 3 is depressed by the user (Step S105). The controller 114 makes judgment depending on whether the operation signal corresponding to the depression of the blue color key has been received at the controller 114.

When the color key has been depressed (Yes at Step S105), the controller 114 generates an image signal for checking the viewing position of the three-dimensional image and instructs the display 113 to display it. The OSD signal generation module 109 generates an image signal and outputs it to the display 113 based on the instruction from the controller 114. On the display 113, the viewing position check screen illustrated in FIG. 3 is displayed (Step S106). When the color key has not been depressed (No at Step S105), the controller 114 waits until the color key is depressed.

The user checks the viewing position check screen displayed on the display 113 to check whether the user is located inside the field (visual field) where the three-dimensional image can be recognized in three dimensions, and if the user is not located inside the visual field, the user moves so that his or her position is located inside the visual field.

After the viewing position check screen is displayed, the controller 114 judges whether the blue color key on the operation module 115 or the remote controller 3 has been depressed (Step S107). The controller makes judgment depending on whether the operation signal corresponding to the depression of the blue color key has been received at the controller 114.

When the color key has been depressed (Yes at Step S107), the controller 114 instructs the OSD signal generation module 109 to generate an image signal for displaying a test pattern of the three-dimensional image and the display 113 to display it. The OSD signal generation module 109 generates the image signal for the test pattern and outputs it to the display 113. On the display 113, the test pattern of the three-dimensional image is displayed (Step S108). When the color key has not been depressed (No at Step S107), the controller 114 waits until the color key is depressed.

The user checks whether the user can actually view the image displayed on the display 113 in three dimensions (Step S109). When the user can view the test pattern in three dimensions (Yes at Step S109), the user operates the decision key on the operation module 115 or the remote controller 3 to end the operation. On the other hand, when the user cannot view the test pattern in three dimensions (No at Step S109), the user operates the BACK (return) key on the operation module 115 or the remote controller 3 to return to the operation at Step S106 and checks the viewing position again.

As described above, when the face detection of the user has been failed, the alert screen illustrated in FIG. 2 is displayed on the display 113 in the three-dimensional image processor 100 according to the embodiment. Therefore, the user can immediately recognize that his or her face has not been detected. Further, the display of the alert screen can be turned ON or OFF by the setting, leading to improved convenience for the user.

In the three-dimensional image processor 100 according to the embodiment, the viewing position check screen illustrated in FIG. 3 is displayed on the display 113. In the display frame 302 of the viewing position check screen, the image imaged by the camera module 119 is displayed, and when the face of the user has been recognized, the recognized face of the user is surrounded by a frame. Therefore, the user can easily check the orientation and the position of his or her own face and whether the face is actually recognized. Further, the display form of the frame (for example, the shape (rectangle, triangle, circle, or the like), the color, the kind of line (solid line, broken line, or the like) of the frame) is different depending on whether the user is located inside or outside the visual field, the user can easily check whether the position of the user is outside or inside the visual field.

In the display frame 303 of the viewing position check screen, the image at the time when the face could not be detected is displayed. Therefore, the user can easily understand why the face detection was failed. Further, in the display frame 304 of the viewing position check screen, the current setting information is displayed. Therefore, the user can easily know the current setting status.

Furthermore, in the display frame 305 of the viewing position check screen, the visual fields 305a (diagonal-line modules) that are fields where the three-dimensional image can be viewed in three dimensions, and the position information (icons indicating users, frames surrounding the icons) of the users calculated by the position calculation module 119d of the camera module 119 are displayed as a bird's eye view. For the position information of each user, the ID provided thereto is displayed in the upper module. Since the display form (for example, the shape (rectangle, triangle, circle, or the like), the color, the kind of line (solid line, broken line, or the like) of the frame) of the frame surrounding the icon indicating the user is different depending on whether the user is located inside or outside the visual field, the user can easily check whether the position of the user is located outside or inside the visual field. Consequently, by referring to the bird's eye view displayed in the display frame 305, the user can easily understand whether or not his or her face is recognized, that, when recognized, the face is located inside the visual field 305a, and that, when the face is located outside the visual field 305a, movement in which direction brings the face into the visual field 305a.

In the image displayed in the display frame 302 and the bird's eye view displayed in the display frame 305, the same ID is displayed for the same user. Therefore, even when a plurality of users, that is, viewers exist, the individual user can easily understand the position where the user is located.

Further, by performing a predetermined operation after FIG. 3 is displayed, the test pattern is displayed on the display 113. The user can check whether the user can actually view the image displayed on the display 113 in three dimensions through the test pattern, leading to improved convenience for the user.

### Other Embodiments

While certain embodiments have been described, these embodiments have been presented byway of example only, and are not intended to limit the scope of the inventions. Indeed, the novel embodiment described herein maybe embodiment in a variety of other forms; furthermore, substitutions and changes in the form of the embodiments described herein may be made without departing from the spirit of the inventions. The accompanying claims and their equivalents are intended to cover such forms or modifications as would fall within the scope and spirit of the inventions.

Though the three-dimensional image processor 100 has been described, for example, taking the digital television as an example in the above embodiment, the present invention is applicable to devices which present a three-dimensional image to the user (for example, a PC (Personal computer), a cellular phone, a tablet PC, a game machine and the like) and a signal processor which outputs an image signal to a display which presents a three-dimensional image (for example, an STB (Set Top Box)). Further, though the relation between the visual field and the position of the user is presented to the user as a bird's eye view (see FIG. 3) in the above-described embodiment, any view other than the bird's eye view may be employed as long as it enables understanding the positional relation between the visual field and the position of the user. Further, though the face of the user is detected and the position information of the user is calculated in the above-described embodiment, other methods may be used to detect the user. In this event, for example, a module part other than the face of the user (for example, the shoulder, the upper body, or the like of the user) may be detected.

What is claimed is:

1. A three-dimensional image processing apparatus comprising:
an imaging module configured to image a field in front of a display, wherein the display is configured to display a three-dimensional image;
a face detection module configured to detect a face of a user from an image imaged by the imaging module; and
a controller configured to, when the face of the user is undetectable by the face detection module, notify that the face is undetectable and control the display to display a first three-dimensional image indicating a field comprising a three-dimensional body.

2. The apparatus of claim 1, further comprising
an operation accepting module configured to accept a first instruction operation to display the first image,
wherein when the operation accepting module accepts the first instruction operation, the controller is configured to control the display to display the first image.

3. The apparatus of claim 1, further comprising
a position calculation module configured to calculate a position of the user,
wherein, when the position of the user calculated by the position calculation module is outside the field comprising the three-dimensional body, the controller is configured to control the display to display that the face was detected and that the position of the user is outside the field comprising the three-dimensional body.

4. The apparatus of claim 3,
wherein the controller is configured to control the display to display the calculated position of the user on the first image.

5. The apparatus of claim 1,
wherein the controller is configured to control the display to display the image imaged by the imaging module.

6. The apparatus of claim 3,
wherein the controller is configured to control the display to display the user in the image imaged by the imaging module in a different display form depending on whether the calculated position of the user is inside the field comprising the three-dimensional body.

7. The apparatus of claim 4,
wherein the controller is configured to control the display to display position information on the user on the first image in a different display form depending on whether the calculated position of the user is inside the field comprising the three-dimensional body.

8. The apparatus of claim 5,
wherein the controller is configured to control the display to display the user in the image imaged by the imaging module and the calculated position of the user on the first image, in an associated manner.

9. The apparatus of claim 2,
wherein the operation accepting module is configured to accept a second instruction operation to display a test pattern for checking whether the first three-dimensional image comprises a three-dimensional body; and
wherein, when the operation accepting module accepts the second instruction operation, the controller is configured to control the display to display the test pattern.

10. The apparatus of claim 1,
wherein, when the face of the user is undetectable, the controller is configured to control the display to display a second image at a time when the face was undetectable.

11. A three-dimensional image processing apparatus, comprising:
an imaging module configured to image a field in front of a display, the display configured to display a three-dimensional image;
a detection module configured to detect a user from an image imaged by the imaging module; and
a controller configured to, when the user is undetectable by the detection module, notify that the user is undetectable and control the display to display a first three-dimensional image indicating a field comprising a three-dimensional body.

12. The apparatus of claim 11,
wherein the controller is configured to control the display to display the image imaged by the imaging module and display the user in the image imaged by the imaging module in a different display form depending on whether a position of the user is inside the field comprising the three-dimensional body.

13. The apparatus of claim 11,
wherein the controller is configured to control the display to display position information on the user on the first image in a different display form depending on whether the position of the user is inside the field comprising the three-dimensional body.

14. A three-dimensional image processing method, comprising:
detecting a face of a user from an image imaged by an imaging module, wherein the imaging module images a field in front of a display, and wherein the display displays a three-dimensional image; and
when the face of the user is undetectable, notifying that the face is undetectable, and controlling the display to display a first three-dimensional image indicating a field comprising a three-dimensional body.
